(19) United States
(12) Patent Application Publication
(10) Pub. No.: US 2014/0095221 A1
(43) Pub. Date: Apr. 3, 2014

(54) SYSTEMS AND METHOD FOR PROVIDING RECOMMENDATIONS

(71) Applicant: CONCUR TECHNOLOGIES, INC., Redmond, WA (US)

(72) Inventors: Michael LORE, Vienna, VA (US); Michael FREDERICKS, Fairfax, VA (US)

(73) Assignee: CONCUR TECHNOLOGIES, INC., Redmond, WA (US)

(21) Appl. No.: 14/036,320

(22) Filed: Sep. 25, 2013

Related U.S. Application Data
(63) Continuation-in-part of application No. 13/830,319, filed on Mar. 14, 2013.
Application No. 13/830,319 is a continuation of application No. 13/712,614, filed on Dec. 12, 2012.
Application No. 13/712,614 is a continuation-in-part of application No. 13/830,410, filed on Mar. 14, 2013.
Application No. 13/830,410 is a continuation of application No. 13/712,629, filed on Dec. 12, 2012.
Application No. 13/712,629 is a continuation-in-part of application No. 13/606,494, filed on Sep. 7, 2012.
Application No. 13/606,494 is a continuation-in-part of application No. 13/602,589, filed on Sep. 4, 2012.
Application No. 13/602,589 is a continuation-in-part of application No. 13/593,108, filed on Aug. 23, 2012.
Application No. 13/602,589 is a continuation-in-part of application No. 13/277,923, filed on Oct. 20, 2011, now Pat. No. 8,620,750.
Application No. 13/602,589 is a continuation-in-part of application No. 13/277,916, filed on Oct. 20, 2011.
Application No. 13/602,589 is a continuation-in-part of application No. 12/901,947, filed on Oct. 11, 2010.
Application No. 13/602,589 is a continuation-in-part of application No. 12/773,282, filed on May 4, 2010.
Application No. 13/602,589 is a continuation-in-part of application No. 11/763,562, filed on Jun. 15, 2007.
Application No. 11/763,562 is a continuation of application No. 10/270,672, filed on Oct. 16, 2002, now abandoned.
Application No. 13/602,589 is a continuation-in-part of application No. 13/396,255, filed on Feb. 14, 2012.
Application No. 13/396,255 is a continuation of application No. 12/755,127, filed on Apr. 6, 2010, now Pat. No. 8,140,361.
Application No. 12/755,127 is a continuation of application No. 10/373,096, filed on Feb. 26, 2003, now Pat. No. 7,720,702.
Application No. 13/602,589 is a continuation-in-part of application No. 13/117,303, filed on May 27, 2011.
Application No. 13/117,303 is a continuation of application No. 11/159,398, filed on Jun. 23, 2005, now Pat. No. 7,974,892.
Application No. 11/159,398 is a continuation-in-part of application No. 13/842,913, filed on Mar. 15, 2013.
Application No. 13/842,913 is a continuation-in-part of application No. 13/593,108, filed on Aug. 23, 2012.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/529,680, filed on Aug. 31, 2011.
(60) Provisional application No. 61/405,480, filed on Oct. 21, 2010.
(60) Provisional application No. 61/405,488, filed on Oct. 21, 2010.
(60) Provisional application No. 61/405,480, filed on Oct. 21, 2010.
(60) Provisional application No. 61/405,488, filed on Oct. 21, 2010.
(60) Provisional application No. 61/324,533, filed on Apr. 15, 2010.
(60) Provisional application No. 61/324,533, filed on Apr. 15, 2010.
(60) Provisional application No. 60/329,281, filed on Oct. 16, 2001.
(60) Provisional application No. 60/581,766, filed on Jun. 23, 2004.
(60) Provisional application No. 61/529,680, filed on Aug. 31, 2011.

(51) Int. Cl. G06Q 10/02

(52) U.S. Cl. CPC G06Q 10/02
USPC 705/5

(57) ABSTRACT

Methods and Systems for providing a recommendation to a user, comprising: examining characteristics of a travel plan; identifying an opportunity that matches the characteristics; identifying a recommendation that matches the opportunity; and providing the recommendation to the user.

### CROSS-REFERENCE TO RELATED APPLICATIONS

This application claims priority to U.S. Provisional Application No. 61/705,265, filed Sep. 25, 2012. This application is also a Continuation-in-Part of U.S. patent application Ser. No. 13/830,319, filed Mar. 14, 2013, which, in turn, is a Continuation of U.S. patent application Ser. No. 13/712,614, filed Dec. 12, 2012, which, in turn, claims the benefit of U.S. Provisional Application Nos. 61/569,942, filed Dec. 13, 2011, 61/569,949, filed Dec. 13, 2011, and 61/705,265, filed Sep. 25, 2012. This application is also a Continuation-in-Part of U.S. patent application Ser. No. 13/830,410, filed Mar. 14, 2013, which, in turn, is a Continuation of U.S. patent application Ser. No. 13/712,629, filed Dec. 12, 2012, which, in turn, claims the benefit of U.S. Provisional Application Nos. 61/569,942, filed Dec. 13, 2011, 61/569,949, filed Dec. 13, 2011, and 61/705,265, filed Sep. 25, 2012. U.S. patent application Ser. No. 13/712,629 is also a Continuation-in-Part of U.S. patent application Ser. No. 13/606,494, filed Sep. 7, 2012. U.S. patent application Ser. No. 13/712,629 is also a Continuation-in-Part of U.S. patent application Ser. No. 13/602,589, filed Sep. 4, 2012, which, in turn, claims the benefit of U.S. Provisional Application Nos. 61/569,942, filed Dec. 13, 2011 and 61/569,949, filed Dec. 13, 2011. U.S. patent application Ser. No. 13/602,589 is a Continuation-in-Part of U.S. patent application Ser. No. 13/593,108, filed Aug. 23, 2012, which, in turn, claims the benefit of U.S. Provisional Application No. 61/529,680, filed Aug. 31, 2011. U.S. patent application Ser. No. 13/602,589 is also a Continuation-in-Part of U.S. patent application Ser. No. 13/277,923, filed Oct. 20, 2011, which, in turn, claims the benefit of U.S. Provisional Application Nos. 61/405,480, filed Oct. 21, 2010, and 61/405,488, filed Oct. 21, 2010. U.S. patent application Ser. No. 13/602,589 is also a Continuation-in-Part of U.S. patent application Ser. No. 13/277,916, filed Oct. 20, 2011, which, in turn, claims the benefit of U.S. Provisional Application Nos. 61/405,480, filed Oct. 21, 2010, and 61/405,488, filed Oct. 21, 2010. U.S. patent application Ser. No. 13/602,589 is also a Continuation-in-Part of U.S. patent application Ser. No. 12/901,947, filed Oct. 11, 2010, which, in turn, claims the benefit of U.S. Provisional Application No. 61/324,533, filed Apr. 15, 2010. U.S. patent application Ser. No. 13/602,589 is also a Continuation-in-Part of U.S. patent application Ser. No. 12/773,282, filed May 4, 2010, which claims, in turn, the benefit of U.S. Provisional Application No. 61/324,533, filed Apr. 15, 2010. U.S. patent application Ser. No. 13/602,589 is also a Continuation-in-Part of U.S. patent application Ser. No. 11/763,562, filed Jun. 15, 2007, which, in turn, is a Continuation of U.S. patent application Ser. No. 10/270,672, filed Oct. 16, 2002 (now abandoned), which, in turn, claims the benefit of U.S. Provisional Application No. 60/329,281, filed Oct. 16, 2001. U.S. patent application Ser. No. 13/602,589 is also a Continuation-in-Part of U.S. patent application Ser. No. 13/396,255, filed Feb. 14, 2012, which, in turn, is a Continuation of U.S. patent application Ser. No. 12/755,127, filed Apr. 6, 2010 (now U.S. Pat. No. 8,140,361, issued Mar. 20, 2012), which, in turn, is a Continuation of U.S. patent application Ser. No. 10/373,096, filed Feb. 26, 2003 (now U.S. Pat. No. 7,720,702, issued May 18, 2010). U.S. patent application Ser. No. 13/602,589 is also a Continuation-in-Part of U.S. patent application Ser. No. 13/117,303, filed May 27, 2011, which, in turn, is a Continuation of U.S. patent application Ser. No. 11/159,398, filed Jun. 23, 2005 (now U.S. Pat. No. 7,974,892, issued Jul. 5, 2011), which, in turn, claims the benefit of U.S. Provisional Application No. 60/581,766, filed Jun. 23, 2004. This application is also a Continuation-in-Part of U.S. patent application Ser. No. 13/842,913, filed Mar. 15, 2013, which, in turn, is a continuation in part of U.S. patent application Ser. No. 13/593,108, filed Aug. 23, 2012 which, in turn, claims the benefit of U.S. Provisional Application No. 61/529,680, filed Aug. 31, 2011. All of the foregoing are incorporated by reference in their entireties for all purposes.

This application is also related to U.S. patent application Ser. No. 11/774,489, filed Jul. 6, 2007 (now abandoned), which is incorporated by reference in its entirety for all purposes.

### BRIEF DESCRIPTION OF THE DRAWINGS

FIG. 1 depicts a network according to an embodiment of the invention.

FIG. 2 depicts a recommendation system server according to an embodiment of the invention.

FIG. 3 depicts a recommendation process according to an embodiment of the invention.

FIG. 4 depicts a recommendation management process according to an embodiment of the invention.

### DETAILED DESCRIPTION OF SEVERAL EMBODIMENTS

Systems and methods described herein may automatically identify and provide recommendations to users. For example, a user may be a traveler or travel agent making travel plans using a computer system. The systems and methods described herein may examine characteristics of the travel plans and identify recommendations or opportunities corresponding to the travel plans. For example, a user may book a flight, and opportunities to rent a car at the destination airport may be identified and presented. Furthermore, the systems and methods described herein may be able to identify changes in a travel itinerary that arise after booking and present new opportunities corresponding to the changes.

The systems and methods described herein may use one or more computers. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant art, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers.

Computers may be interconnected via one or more networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via WiFi, WiMax, or other wireless connection). Connections between computers may use any protocols, including connection oriented protocols such as TCP or connectionless protocols such as UDP. Any connection through which at least two computers may exchange data may be the basis of a network.

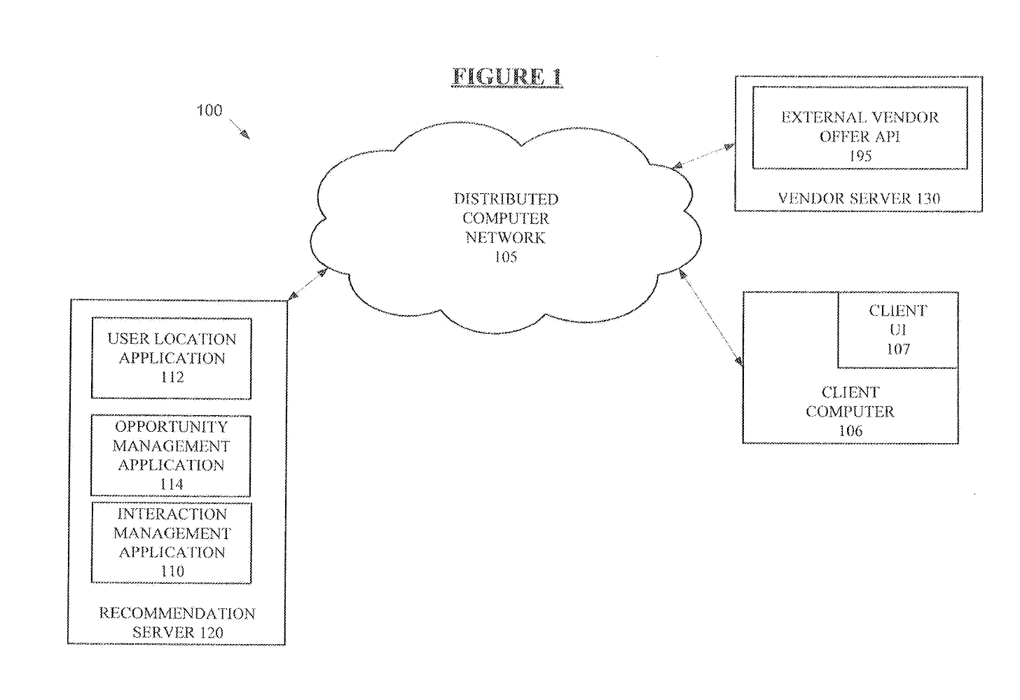

FIG. 1 depicts a network 100 according to an embodiment of the invention. The network 100 of FIG. 1 may comprise one or more computers in communication with one another via a distributed computer network 105 such as the internet. Those of ordinary skill in the art will appreciate that other embodiments may comprise computers that are interconnected via other types of networks. One or more of the computers in the network 100 may be client computers 106 which may include client user interfaces (UIs) 107. For example, a client computer 106 may be the computer of a user or travel agent who is making travel plans, and a client UI 107 may be a program or website that enables the user to book travel arrangements. The network 100 may include one or more recommendation servers 120, which may include interaction management applications 110, user location applications 112, and/or opportunity management applications 114, which are described in greater detail below. One or more vendor servers 130 may also be in communication with the recommendation server(s) 120 and/or client computer(s) 106 via the distributed computer network 105. The vendor servers 130 may include external vendor offer application programming interfaces (APIs) 195, which are described in greater detail below.

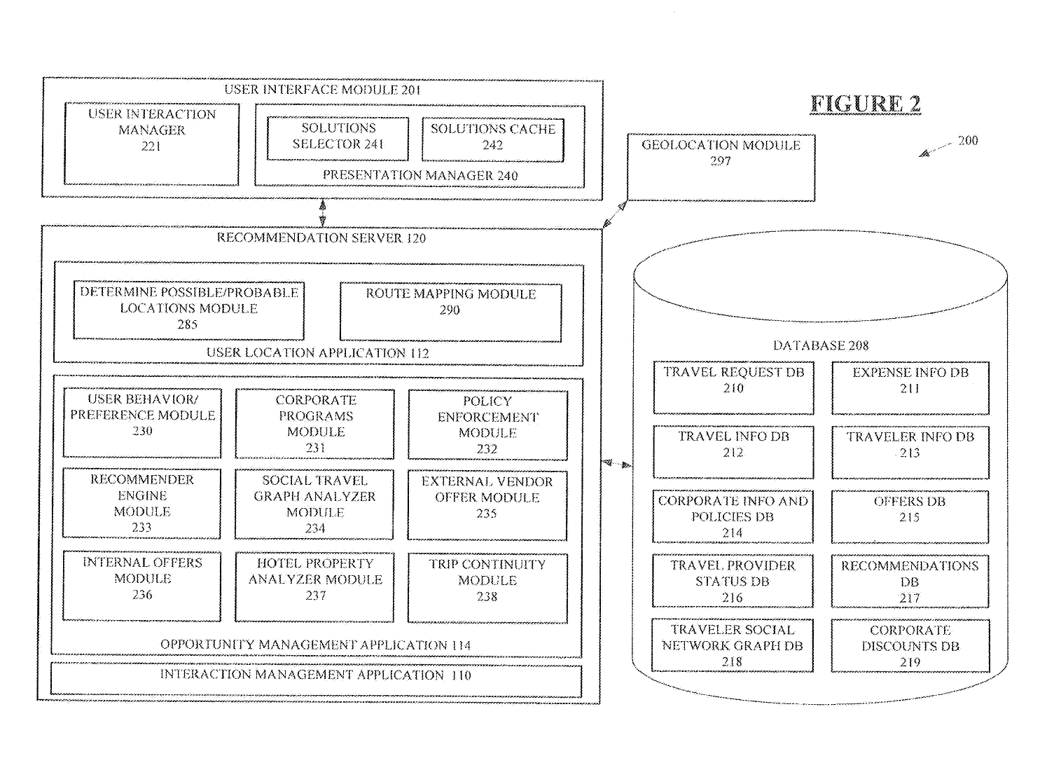

FIG. 2 depicts a recommendation system 200 according to an embodiment of the invention. The recommendation system 200 may be a single computer system or may comprise multiple computers which may be physically separate from one another in some embodiments. The recommendation system 200 may include a user interface module 201, which may be part of or communicate with the client computer 106 or vendor server 130. The user interface module 201 may include a user interaction manager 221 and/or a presentation manager 240. The presentation manager 240 may include a solutions selector 241 and/or a solutions cache 242. The recommendation system 200 may also include a geolocation module 297, which may determine a location of a userFor example, the geolocation module 297 may be a component of a client computer 106 performing GPS or cellular triangulation.

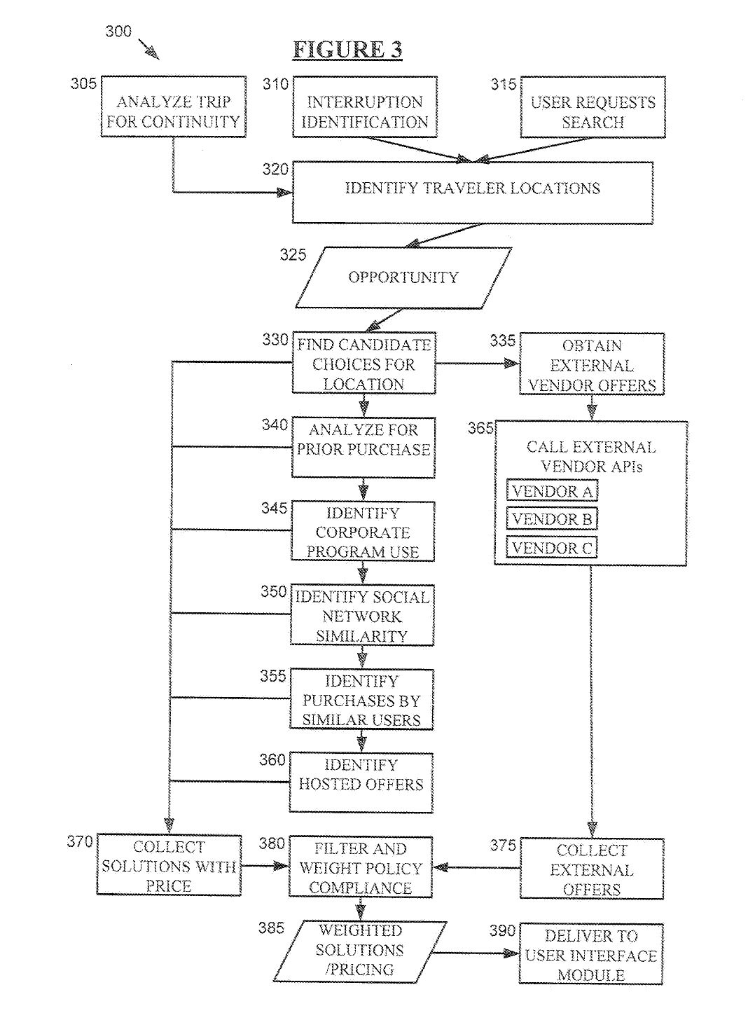

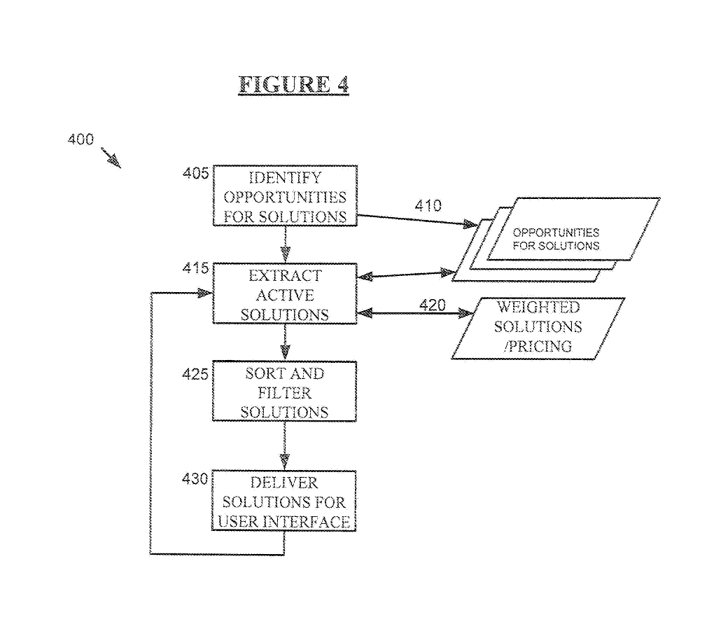

The recommendation system 200 may also include the recommendation server 120, which may be in communication with the user interface module 201 and/or the geolocation module 297. The recommendation server 120 may include an interaction management application 110. The recommendation server 120 may also include a user location application 112, which may include a determine possible/probable locations module 285 and/or a route mapping module 290, whose functions are described below in the context of FIGS. 3-4. The recommendation server 120 may further include an opportunity management application 114. The opportunity management application 114 may include a user behavior/preference module 230, a corporate programs module 231, a policy enforcement module 232, a recommender engine module 233, a social travel graph analyzer module 234, an external vendor offer module 235, an internal offers module 236, a hotel property analyzer module 237, and/or a trip continuity module 238, the functions of which are described in the context of FIGS. 3-4 below.

The recommendation system 200 may also include a database 208, which may be in communication with the recommendation server 120. The database 208 may be a physical component of the recommendation server 120 or it may be wholly or partially separate from the recommendation server 120. The database 208 may comprise one or more data storage devices, and may be divided physically and/or logically into several separate databases. These separate databases may include a travel request database 210, an expense info database 211, a travel info database 212, a traveler info database 213, a corporate info and policies database 214, an offers database 215, a travel provider status database 216, a recommendations database 217, a traveler social network graph database 218, and/or a corporate discounts database 219, the contents and/or functions of which are described in the context of FIGS. 3-4 below.

FIG. 3 depicts a recommendation process 300 according to an embodiment of the invention. In this example embodiment, three prompts may be provided at which the system may be invoked to identify opportunities and/or provide recommendations or offers to a user such as a traveler or assigned arranger. In other embodiments, other and/or different prompts may be provided. The route mapping module 290 may determine locations in time and space for a traveler, and this data may be updated as a trip's characteristics change. As the traveler or assigned arranger, for example a travel agent or designated fellow employee, makes changes to a trip, the characteristics of the trip may be analyzed for continuity by the trip continuity module 238 at 305. For example, the current trip content may be analyzed by identifying both in what possible locations the traveler could be in 320, and/or by finding possible opportunities to make offers or recommendations in 325. As an example, the system may identify the presence of an arriving air booking and a hotel stay in a particular city, but notice that there is no transportation between the arrival airport and the hotel stay. Continuity analyses may create an opportunity to provide a transportation offer or recommendation between the airport and the hotel. As one skilled in the art can see, this is just one example of the many types of opportunities that can be identified between one type of inventory, an airport, and another type, a hotel. There are many other possible opportunities both between these types of inventory and between the multiple permutations of inventory possible.

Interruption identification may track travel interruption changes at 310. Interruption changes may be received from airline or rail schedule changes and/or other itinerary changes such as hotel cancellations from multiple sources, including but not limited to 3^{rd} party providers, airline and airport feeds, and/or itinerary updates received from global distribution systems (GDSs) and direct connections to airlines, rail, hotel, and other travel providers. For example, when a change on a traveler's trip that affects their schedule is identified, the itinerary may be analyzed to see what other additional items on the traveler's itinerary may be affected. The computer may identify the changed items and all subsequently affected items as opportunities. In addition, further analysis of the changes may be done by the determine possible/probable locations module 285 to determine in what location the traveler will be as a result of the change in 320. For example, in the case that an interruption represents a flight diversion or a routing change, the traveler may be located in one of several locations including where their trip had them previously, the new destination, or at the departure point. Opportunities may be identified based on the traveler's location in 325. As one skilled in the art can appreciate, these are just some of the possible locations a traveler may end up in as the result of an interruption, and multiple sources may trigger an interruption notification.

A user may also request a search in 315. The computer may identify opportunities as a user searches for something to add to their trip, for example a hotel. Based on the search query, there may be opportunities based on the dates and times for which the user is interested in reserving or buying a particular travel item, which may be identified in 320. The location may come from the user searching for a particular location, or by information obtained by geolocation performed by the geolocation module 297. Opportunities related to these locations may be identified in 325.

Having identified through any of the above methods one or more opportunities in 325, the computer may identify one or more possible candidate solutions for a location in 330. For a hotel, the candidate solutions may be in the form of a list of hotels and their available regularly-listed rates within a certain range around the location of user interest, for example.

From the list of candidate solutions, the computer may extract a set of vendors that have built support for the external vendor API in 335. When vendors are identified, the computer may make a request to those vendors' systems, passing along the information about the opportunity in 365. The information provided to vendors may include, but is not limited to, the date and location of the opportunity as well as information about the user for whom a reservation or purchase will be made. The information may also include, where available, the user's affinity program number for that vendor, if the user has one and it has been entered into the traveler info database 213, as well as any clustering information developed by the user through the recommender engine module 233. External offers may be received by the computer in 375. The external offers may be results sent back from external vendors responding to the calls made to them in 365.

The computer may also analyze for prior purchases in 340. This may be done substantially simultaneously with obtaining external vendor offers in 335. The list of candidate solutions for an opportunity may be reviewed against the historical record of the user's travel itineraries from the travel info database 212 and expensed items in the expense info database 211. Candidate solutions matching a prior travel itinerary item or expense item may be flagged as a prior purchase by the user behavior/preference module 230.

In addition to analyzing for prior purchase, candidate solutions may be evaluated against the corporate travel and purchase programs of the company on whose behalf the user is identified as traveling in 345, if applicable. The candidate solutions may be matched against any discounts or preferences the company may have for a particular vendor and may be flagged as being part of the corporate program by the corporate programs module 231.

The candidate solutions may be weighted by the social travel graph analyzer module 234 based on social network information in 350. This information may be generated about those solutions from members of the user's social graph, for example using connections either by explicit building of relationships (for example by corporate hierarchy), or by the user actively building connections to other travelers. This information may be stored in the traveler social network graph database 218. Purchase behavior by members of the social network, as well as identified likely candidates based on similarity of various criteria of the candidate solutions to criteria on social network members' purchase choices, may add a flag to those candidate solutions.

Purchases made by similar users may be identified in 355. These purchases may be identified through inferred relationships such as peers by title or location in other corporate entities' hierarchies, compatible prior purchase behaviors, and/or other similar criteria. Items in the candidate solutions that may be of interest to the user based on similar purchase behavior in those inferred relationships may be identified and flagged accordingly.

Hosted offers may be identified in 360. Offers hosted in the offers database 215 may be queried. A hosted offer may be an offer out of a database instead of, for example, sending marketing data to a vendor and seeking offers back from the vendor. Candidate solutions may be compared against and supplemented by the offers in the database for the opportunity type. When a particular candidate solution matches an offer from the offers database, the pricing for that solution may be adjusted accordingly. When an offer from the offers database is not currently in the list of candidate solutions, that offer may be added to the set of candidate solutions and flagged as a hosted offer.

The results from the analysis in 330, 340, 345, 350, 355, or 360, or any combination thereof may be collected in 370.

The internal and external results may be merged and filtered in 380. Solutions may be filtered based on criteria, such as compliance with corporate policy, by flagging candidate solutions against the corporate info and policies database 214 for being in policy or identifying which policies they violate, for example. Some policy definitions may cause candidate solutions to be filtered out completely. After compliance is evaluated, the candidate solutions may be weighted based on an algorithm that determines the likely suitability of each candidate solution to the user based on what flags have been marked on each candidate solution. The algorithm may add additional weights for any or all of the items 330, 340, 345, 350, 355, and 360 for which a candidate solution has been flagged. The amount of weighting may be varied based on recipes, which may be controlled by corporate policy as stored in the corporate info and policies database 214. For example, prior reservation or expensing of a candidate solution may be assigned a very high weight, with corporate program use, social network similarity, purchase by similar users based on overall purchase history, and offers generated by the internal offers module 236 receiving decreasing weights. The external offers collect in 375 may also be weighted by the system and, where the offer matches the inventory of a solution in 380, the external offer and associated pricing may be merged into the solution and additional weighting added in 385.

The resulting set of weighted solutions and pricing may be gathered in 385 and delivered to the user interface module 201 in 390, and the weighted solutions may be stored in the solutions cache 242.

FIG. 4 depicts a recommendation management process 400 according to an embodiment of the invention. The computer may perform this process 400 upon receiving a set of weighted solutions and pricing in order to handle management and caching of those solutions. Information may be presented in response to various device inputs, for example a user viewing an existing trip itinerary, the user starting to search for travel inventory, a timed event triggered by the start of an upcoming travel inventory item, and/or a pushed notification identified via the interruption identification system in 310 or analyze trip for continuity in 305 discussed with respect to FIG. 3 above. When information is to be presented, the user interface module 201 may call the solutions selector 241 to identify opportunities for which solutions can be presented in 405. Opportunities for solutions may be identified in 410, and then relevant solutions may be found for the identified opportunities.

For each opportunity, the solutions selector 241 may extract active solutions in 415. Relevant weighted solutions may be identified in the solutions cache 242 in 420. A weighted solution may be determined to be active if it was generated for an opportunity currently being presented to the user and is also valid for the time period when the user is being presented with weighted solutions for that particular opportunity. Some weighted solutions, for example those coming from the external vendor offer module 235 or the internal offers module 236, may have time restrictions on when they can be presented that may be for some point in time in the future, at present, and/or in the past. The solutions cache 242 may purge solutions whose validity is expired. Validity may expire because the time limit determined by the vendor has passed and/or because the time window during which the user could use the opportunity has passed.

Once a set of active solutions for the opportunity types has been identified, the solutions selector 241 may sort and filter the active solutions based on their weighting in 425, which may generate a set that may contain particularly relevant solutions for the current opportunity. Solutions may be sorted with highest weight first, and then the solutions selector 241 may determine the best number of solutions to present. This determination may be based on various factors including the target device's capabilities, target display size/resolution, and/or the effectiveness of a quantity of solutions on the likelihood of a user choosing an offered solution.

The computer may deliver an optimal number of solutions, as selected in 425, to the user interaction manager 221, along with their pricing, in 430. Steps 415-430 may be repeated for each opportunity identified in 405.

In an embodiment, a user may: receive a prompt to identify opportunities for presentation to a user, the prompt being associated with a plan; identify a location associated with the user; identify a plurality of opportunities associated with the location: filter the plurality of opportunities to generate a plurality of filtered opportunities; weigh the plurality of filtered opportunities to generate a set of relevant opportunities; and deliver the weighted set of relevant opportunities to a display.

In an embodiment, the prompt may comprise an analysis of plan elements, a detection of a change in the plan, a search request, or any combination thereof.

In an embodiment, the plan may comprise a travel plan, and the plurality of relevant opportunities may comprise offers to purchase travel plan components.

In an embodiment, the location associated with the user may be determined. For example, information from a user's calendar (e.g., Outlook) and/or other source (e.g., itinerary) may provide information about where a user believes they are going to be on a certain day and time, and that information may be incorporated into a recommendation. The geolocation module may comprise a GPS module and/or a cellular triangulation module. Identifying the plurality of opportunities associated with the location may comprise: sending a request for external vendor offers to a computer associated with an external vendor; and receiving at least some of the plurality of opportunities from the computer associated with an external vendor. In an embodiment, determining the plurality of opportunities associated with the location may comprise identifying an opportunity associated with a prior purchase by the user. Identifying the plurality of opportunities associated with the location may comprise identifying an opportunity associated with: a corporate program associated with the user; a social network characteristic of the user; a prior purchase by a second user having a characteristic similar to a characteristic of the user; or a hosted opportunity, or any combination thereof. Identifying the plurality of opportunities associated with the location may also comprise identifying a characteristic for each of the plurality of opportunities and filtering the plurality of opportunities based on a corporate policy associated with the user and the characteristic for each of the plurality of opportunities; identifying an active or inactive status for each of the plurality of opportunities and filtering the plurality of opportunities based on the active or inactive status for each of the plurality of opportunities; or identifying a characteristic for each of the plurality of opportunities and weighing the plurality of opportunities based on the characteristic for each of the plurality of opportunities; or any combination thereof.

There are several examples where recommendation system 200 may improve the travel booking experience. For example, travelers often book air tickets in advance of a trip, and defer procurement of hotel or ground transportation. Even when travelers book hotels at roughly the same time as the flight, if the air and hotel are bought at different sites or from different vendors, they likely will be purchased in a sequence. If a traveler were using an itinerary management system, such as TripIt®, where all itineraries are aggregated in a single tool, then when that tool receives an itinerary for air that implies an overnight stay (e.g., a round trip with a return flight departing on a later date than the arrival date), that tool could recommend either on screen or via an email or other alert a specific hotel that might be suitable. If the tool were to also have access to calendar information and know the location of meetings on the day of travel, the recommendation could include that geography into the recommendation algorithm. Likewise, if the itinerary management system received a hotel reservation and had no corresponding air itinerary, then the itinerary management system could recommend appropriate flights, knowing the dates of travel, the times of any meetings (e.g., if there were calendar integration), the user's home airport, preferred airlines, etc.

Another example would be to take advantage of recommendations to help reduce the cognitive load of choosing an appropriate travel itinerary. Over the last several years, travel search technologies have improved and now hundreds and sometimes thousands of options can be presented to a person planning travel. It can then become difficult to determine which of those options are the best options for the specific traveler. While some art focuses on how best to concisely present the data, recommendations can be used to sharply reduce the number of options that need to be considered. If a traveler were to indicate that they wish to go from Washington, D.C. to San Francisco, Calif., a travel booking interface could present a small number of itineraries prominently (e.g., at the top of the screen) to the traveler. The interface could, for example, show three flight choices, one that is the one that fits the traveler's past purchase habits as far as preferred airlines and cost, one that focused on a balance between cost and time in the air, and a third that would be the most preferred based on corporate policy. Practitioners would recognize that other criteria could be used to determine the prominently displayed flights and there are other ways to prominently display data, that greater or fewer than three could be displayed, and that these methods can vary based on device. If one of the three flight choices made sense to the traveler, it could be reserved, and if they did not, then they could be discarded and the traveler could sift through all of the choices available similar to how they do today. If the recommendations are chosen sufficiently often, then the overall time spent choosing flights by the entire user population declines, giving economic and other benefits. This same methodology can apply to hotel recommendations. Hotels can be recommended based on location of meetings, where the traveler has stayed before (both in the chosen geographic area and in others), where the traveler's colleagues or social connections are staying or have stayed, what brands the traveler prefers based on frequent guest numbers or previous stays, or other criteria. Recommended hotels can be displayed at the top of the screen similar to the previous example on flights.

Any of these examples could also apply to other travel reservation types, such as rail, limousine, or rental car. Additionally, these same recommendations could be used to help guide travelers as to whether to take rail or a flight, or rent a car vs. hire a taxi.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, in addition or alternative to the travel-related scenarios described above, the systems and methods described herein may be applied to any dynamic set of information. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Additionally, the term “comprising”, “including” or similar terms in the specification, claims and drawings should be interpreted as meaning “including, but not limited to.”

Finally, it is the applicant's intent that only claims that include the express language “means for” or “step for” be interpreted under 35 U.S.C. 212, paragraph 6. Claims that do not expressly include the phrase “means for” or “step for” are not to be interpreted under 35 U.S.C. 212, paragraph 6.

What is claimed is:

1. A method for providing a recommendation to a user, comprising:
examining, using a processing device, characteristics of a travel plan;
identifying, using the processing device, an opportunity that matches the characteristics;
identifying, using the processing device, a recommendation that matches the opportunity; and
providing, using the processing device, the recommendation to the user.
